(19) United States
(12) Patent Application Publication
(10) Pub. No.: US 2005/0103487 A1
(43) Pub. Date: May 19, 2005

(54) Vapor compression system for heating and cooling of vehicles

(76) Inventors: Kare Aflekt, Trondheim (NO); Arne Jakobsen, Trondheim (NO); Jostein Pettersen, Ranheim (NO); Geir Skaugen, Trondheim (NO); Armin Hafner, Trondheim (NO); Petter Neksa, Trondheim (NO); Havard Rekstad, Trondheim (NO); Gholam Reza Zakeri, Bad Vilbel (DE)

Correspondence Address: WENDEROTH, LIND & PONACK, L.L.P., 2033 K STREET N. W., SUITE 800, WASHINGTON, DC, 20006-1021, US

(21) Appl. No.: 10/498,809

(22) PCT Filed: Nov. 25, 2002
(86) PCT No.: PCT/NO02/00440

(30) Foreign Application Priority Data
Dec. 19, 2001 (NO) 20016217

(51) Int. Cl. B60H 1/00; F25B 29/00; B61D 27/00; B60H 3/00; F25B 41/00

(52) U.S. Cl. 165/202; 165/240; 165/42; 165/43; 165/61; 62/513; 237/2 B

(57) ABSTRACT

Reversible vapor compression system including a compressor (1), an interior heat exchanger (2), an expansion device (6) and an exterior heat exchanger (3) connected by means of conduits in an operable relationship to form an integral main circuit. A first means is provided in the main circuit between the compressor and the interior heat exchanger, and a second means is provided on the opposite side of the main circuit between the interior and exterior heat exchangers to enable reversing of the system from cooling mode to heat pump mode and vice versa.

### FIELD OF THE INVENTION

The present invention relates to reversible vapor compression system for heating and comfort cooling of a vehicle cabin or passenger compartment, including at least a compressor, a flow reversing device, an interior heat exchanger, a multi-function expansion device, an internal heat exchanger, an exterior heat exchanger, another multi-function expansion device, an auxiliary heat exchanger through which a coolant is circulated and an accumulator connected in an operational relationship to form a closed main circuit. The system is operating under trans-critical or sub-critical conditions using any refrigerant and in particular carbon dioxide. More specifically the system is related to reversible refrigeration/heat pump systems for vehicles operating with electrical, internal combustion or hybrid drive systems.

### DESCRIPTION OF PRIOR ART

In reversible vapor compression systems for mobile applications, it is desirable to use waste heat from the drive system of the vehicle, and/or from ambient air, as a heat source for the vapor compression system when it is operated in heat pump mode. The vehicle drive system may have one or more engines, electric motors, fuel cells, power electronics units and/or batteries, all of which may give off waste heat.

Patent, DE19813674C1, discloses a reversible heat pump system for automobiles where exhaust gas from the internal combustion engine is used as heat source. The disadvantage of this system is the possibility of oil decomposition in the exhaust gas heat recovery heat exchanger (when not in use) as the temperature of the exhaust gas is relatively high. Another disadvantage is the corrosion problems that may occur on the exhaust-side in the heat recovery heat exchanger. A third disadvantage is the considerable size of the exhaust/refrigerant heat exchanger, and its vulnerable position under the vehicle. A fourth disadvantage of this system is that the pressure in the high side of the circuit cannot be controlled when the circuit is operated in heat pump mode. This may give operational problems such as insufficient capacity and low efficiency. Finally, a fifth disadvantage of this system is the absence of an internal heat exchanger in the circuit. Without this heat exchanger, the system will not achieve maximum capacity and efficiency in cooling-mode operation at high ambient temperature.

Additionally a patent application, DE19806654, describes a reversible heat pump system for motor vehicle powered by an internal combustion engine, where the engine coolant system is used as heat source. The disadvantage of this system is that it can only absorb heat from the engine coolant circuit, and at start-up, this may delay the heating-up time of the engine coolant and the engine itself. Consequently, the engine needs more time to reach normal temperature, with increased pollutant emission and fuel consumption as a likely result. In addition, the system may have to operate with extremely low evaporating temperature at start-up. Another disadvantage with this system is the inability to provide dehumidification of the passenger compartment air in heat pump mode, which may give reduced windshield defogging or defrosting effect compared to a system with dehumidification options.

### SUMMARY OF THE INVENTION

The present invention introduces a new improved vapor compression system for vehicle comfort cooling and heating where the said system can utilize waste heat both from the vehicle drive system and from ambient air as a heat source in heating mode, and as heat sink in cooling mode. The invention is characterized by the features as defined in the attached independent claim 1.

In some of its embodiments, as defined in the dependent claims 2-18, the system can offer dehumidification in heat pump mode. The system is primarily intended for (but not limited to) use in vehicles having a coolant fluid circuit that exchanges heat with an internal combustion engine, an electric motor or a hybrid drive system.

The system can supply heat to the engine coolant circuit through the auxiliary heat exchanger for more rapid engine heating and to reduce the heat load on the exterior heat exchanger when the system is operated in cooling mode. When operating in heat pump mode the system can use the coolant system fully or partially as a heat source. The reversing process from heat pump to cooling mode operation, and vice versa, can be performed by means of a flow reversing device and two multi-function expansion devices.

### BRIEF DESCRIPTION OF THE DRAWINGS

The invention is described in more details by way of examples and by reference to the following figures, where:

FIG. 1 is schematic representation of the First embodiment in heat pump mode operation.

FIG. 2 is schematic representation of the First embodiment in cooling mode operation

FIG. 3 is schematic representation of the Second embodiment in heat pump mode operation.

FIG. 4 is schematic representation of the Second embodiment in cooling mode operation

FIG. 5 is schematic representation of the Third embodiment in heat pump mode operation.

FIG. 6 is schematic representation of the Third embodiment in cooling mode operation.

FIG. 7 is schematic representation of the Fourth embodiment in heat pump mode operation.

FIG. 8 is schematic representation of the Fourth embodiment in cooling mode operation.

FIG. 9 is schematic representation of the Fifth embodiment in heat pump mode operation.

FIG. 10 is schematic representation of the Fifth embodiment in cooling mode operation.

FIG. 11 is schematic representation of the Sixth embodiment in heat pump mode operation.

FIG. 12 is schematic representation of the Sixth embodiment in cooling mode operation.

FIG. 13 is schematic representation of the Seventh embodiment in heat pump mode operation.

FIG. 14 is schematic representation of the Seventh embodiment in cooling mode operation.

FIG. 15 is schematic representation of the Eighth embodiment in heat pump mode operation.

FIG. 16 is schematic representation of the Eighth embodiment in cooling mode operation.

FIG. 17 is schematic representation of the Ninth embodiment in heat pump mode operation.

FIG. 18 is schematic representation of the Ninth embodiment in cooling mode operation.

FIG. 19 is schematic representation of the Tenth embodiment in heat pump mode operation.

FIG. 20 is schematic representation of the Tenth embodiment in cooling mode operation.

FIG. 21 is schematic representation of the Eleventh embodiment in heat pump mode operation.

FIG. 22 is schematic representation of the Eleventh embodiment in cooling mode operation.

FIG. 23 is schematic representation of the Twelfth embodiment in heat pump mode operation.

FIG. 24 is schematic representation of the Twelfth embodiment in cooling mode operation.

FIG. 25 is schematic representation of the Thirteenth embodiment in heat pump mode operation.

FIG. 26 is schematic representation of the Thirteenth embodiment in cooling mode operation.

FIG. 27 is schematic representation of the Fourteenth embodiment in heat pump mode operation.

FIG. 28 is schematic representation of the Fourteenth embodiment in cooling mode operation.

FIG. 29 is schematic representation of the Fifteenth embodiment in heat pump mode operation.

FIG. 30 is schematic representation of the Fifteenth embodiment in cooling mode operation.

FIG. 31 is schematic representation of the Sixteenth embodiment in heat pump mode operation.

FIG. 32 is schematic representation of the Sixteenth embodiment in cooling mode operation.

FIG. 33 is schematic representation of the Seventeenth embodiment in heat pump mode operation.

FIG. 34 is schematic representation of the Seventeenth embodiment in cooling mode operation.

### DETAILED DESCRIPTION OF THE INVENTION

The disclosed vapor compression system is intended for (but not limited to) use in vehicles, i.e. transport means such as automobiles, trains, trucks, buses and aircraft, where there is a need for cooling or heating for comfort purposes, and where some waste heat is available from the drive system that may serve as a heat source when the vapor compression system is operated in heat pump mode. The vehicle drive system may include one or more of the following components: internal combustion engine, engine of other type, electric motor, fuel cells, batteries, and power electronic systems, all of which need to reject some waste heat during operation. In the disclosed system it is assumed that the drive system components reject heat through a coolant circuit where a coolant fluid is circulated through the drive system. The coolant circuit may use a single-phase fluid (liquid or gas) or it may use a two-phase fluid. Usually, the coolant system also contains a radiator where heat can be rejected to ambient air. The disclosed vapor compression system consists of a refrigerant circuit containing an interior heat exchanger, an exterior heat exchanger, an auxiliary heat exchanger through which the coolant fluid is circulated, an internal heat exchanger which exchanges heat inside the refrigerant circuit, an accumulator, a compressor, and flow-controlling devices. The interior heat exchanger absorbs heat from the passenger compartment or cabin in comfort cooling mode, and transfers heat to the passenger compartment or cabin in heating mode. Heat may either be transferred directly to/from the passenger compartment/cabin air that is circulated through the interior heat exchanger, or heat may be transferred indirectly through a secondary fluid. The exterior heat exchanger absorbs heat from the ambient air in heat pump mode, and rejects heat to ambient air in comfort cooling mode. Heat may either be transferred directly to/from ambient air that is circulated through the exterior heat exchanger, or heat may be transferred indirectly through a secondary fluid.

When the vehicle is started from cold conditions in low ambient temperature, it is desirable to have a rapid heating up of the passenger compartment/cabin, and the drive system components should also reach normal operating temperature as fast as possible. In order to achieve this, the disclosed system absorbs heat from ambient air through the exterior heat exchanger in the initial period of operation after start-up in heat pump mode. The drive system components are thus allowed to reach normal temperature quickly, since no heat is taken from the coolant circuit. In fact, the added load on the drive system due to the heat pump compressor power requirements makes the temperature of the components and the coolant fluid rise more rapidly. Heat is supplied to the passenger compartment/cabin by the heat pump through the interior heat exchanger. When the drive system components and the coolant circuit temperatures have reached a suitable temperature level, the heat pump operation is changed into using coolant as a heat source instead, by absorbing heat from the coolant circuit through the auxiliary heat exchanger. Eventually, the heat pump may be switched off and the cabin/passenger compartment heated directly by the coolant circuit through a separate heat exchanger (heater core). It is also possible to operate the heat pump system by a combination of ambient air and coolant as heat sources, and to heat the passenger compartment/cabin by a combination of interior heat exchanger and heater core. In some embodiments of the system, the interior heat exchanger can offer bi-functionality in heat pump mode, in that part of the heat exchanger is used to dehumidify the air by cooling it, whereas the remaining part of the interior heat exchanger serves as an air heater.

When the vehicle is started in high ambient temperature, it is desired to reduce the passenger compartment/cabin air temperature as quickly as possible, and the vapor compression system is then operated in comfort cooling mode. Heat is now absorbed from the passenger compartment/cabin air through the interior heat exchanger. If the coolant fluid and drive system temperature is lower than the desired level at start-up, waste heat from the vapor compression system may be given off to the coolant circuit through the auxiliary heat exchanger. This heat input to the coolant circuit may allow the drive system components to reach optimum operation temperature more rapidly. Heat may also be rejected from the vapor compression system to the coolant circuit when the drive system components are at their normal temperature level. By reducing heat load on the exterior heat exchanger in this way, the vapor compression system capacity and efficiency may be improved. This mode of operation of course depends on sufficient heat rejection capacity in the coolant circuit radiator. The distribution of heat input between the auxiliary heat exchanger and the exterior heat exchanger can be controlled by bypass arrangements and flow-control devices.

The vapor compression circuit is switched between heat pump mode and comfort cooling mode, and between varying modes of heat absorption and heat rejection, by using flow-reversing devices, flow-diverting devices, and multi-function expansion devices. The flow-reversing devices may be four-way valves, combinations of three-way valves, or other flow arrangements providing reversing of the flow direction in the circuit. The flow-diverting devices may be three-way valves, combinations of ordinary valves, or other flow arrangements providing diversion of flow between two branches in the flow circuit. The multi-function expansion devices provide refrigerant expansion in one direction and unrestricted flow in one or both directions, depending on the mode of operation. The multi-function expansion devices may include any combination of throttling means, expansion machines or turbines with or without work recovery, and flow control means.

### 1. FIRST EMBODIMENT

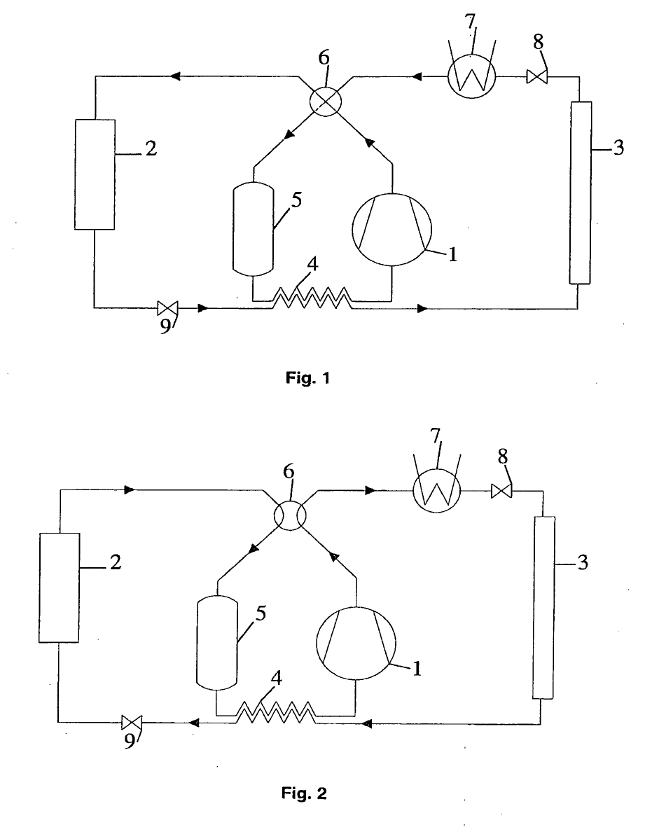

The First embodiment of the present invention for a reversible vapor compression cycle is shown schematically in FIG. 1 in heat pump mode and FIG. 2 for comfort cooling operation. In accordance with the present invention, the device includes a compressor 1, a flow-reversing device 6, an interior heat exchanger 2, a multi-function expansion device 9, an internal heat exchanger 4, an exterior heat exchanger 3, another multi-function expansion device 8, an auxiliary heat exchanger 7 and an accumulator 5. The system operation in heat pump and cooling mode is described with reference to FIG. 1 and FIG. 2 respectively.

Heat Pump Operation (FIG. 1):

When the system is running as heat pump, the compressed refrigerant after the compressor flows first through a flow-reversing device 6 that is in heating mode. The refrigerant then enters the interior heat exchanger 2, giving off heat to the heat sink (cabin/passenger compartment air, or secondary fluid) before passing through the multi-function expansion device 9 which is open, i.e. the pressure before and after is basically the same. The high-pressure refrigerant then passes through the internal heat exchanger 4 where its temperature (enthalpy) is reduced by exchanging heat with low-pressure refrigerant. The cooled high-pressure refrigerant then enters exterior heat exchanger 3 before its pressure is reduced to the evaporation pressure by the multi-function expansion device 8. The low-pressure refrigerant enters the auxiliary heat exchanger 7 where it evaporates by absorbing heat. The amount of heat absorbed in the auxiliary heat exchanger 7 and exterior heat exchanger 3 can be controlled by controlling coolant fluid and/or air flow rate respectively. The refrigerant then passes through the flow-reversing device 6, the low-pressure accumulator 5 and the internal heat exchanger 4 respectively, before it enters the compressor, completing the cycle.

Cooling Mode Operation (FIG. 2):

The flow-reversing device 6 will now be in cooling mode operation such that the interior heat exchanger 2 acts as evaporator while the exterior heat exchanger 3 act as heat rejector (condenser/gas cooler). In this mode, the compressed gas after compressor 1 passes through the flow-reversing device 6 before entering auxiliary heat exchanger 7. Depending on whether auxiliary heat exchanger 7 is in operation (for example during start-up period in order to get the engine temperature up to normal temperature which can reduce the emission of undesired gases which is typical for internal combustion engine), the high-pressure refrigerant can be cooled down before it passes through the multi-function expansion device 8 without substantial pressure reduction (the pressure before and after remains basically constant). The high-pressure refrigerant then enters the exterior heat exchanger 3 where it is cooled down by giving off heat to the heat sink. The refrigerant is further cooled down in the internal heat exchanger 4 before its pressure is reduced to evaporation pressure by the multi-function expansion device 9. The low-pressure refrigerant evaporates by absorbing heat in the internal heat exchanger 2. The refrigerant then passes through the flow-reversing device 6, accumulator 5 and the internal heat exchanger 4 respectively, before it enters the compressor 1, completing the cycle.

### 2. SECOND EMBODIMENT

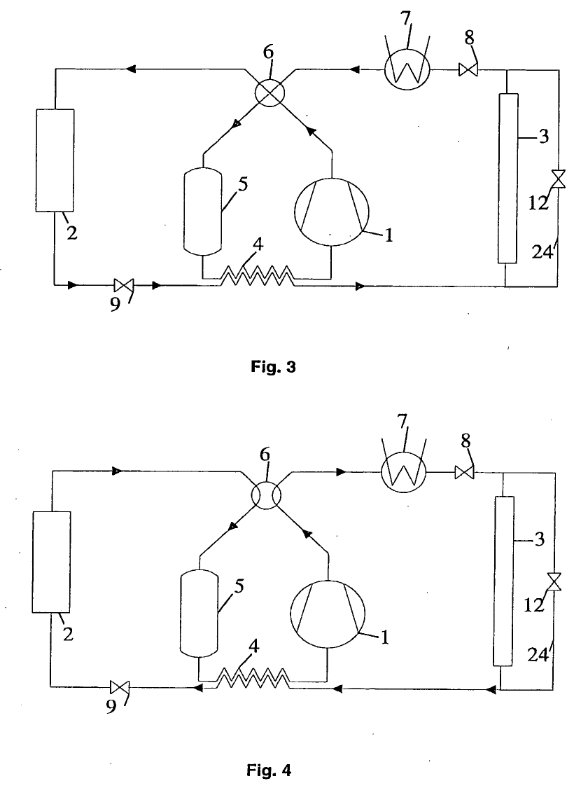

The second embodiment is shown schematically in FIG. 3 and FIG. 4 in heat pump and cooling mode respectively. The main difference between this embodiment and the First embodiment is the presence of a bypass conduit 24 providing a valve 12 which add the option to bypass the exterior heat exchanger 3 if needed.

### 3. THIRD EMBODIMENT

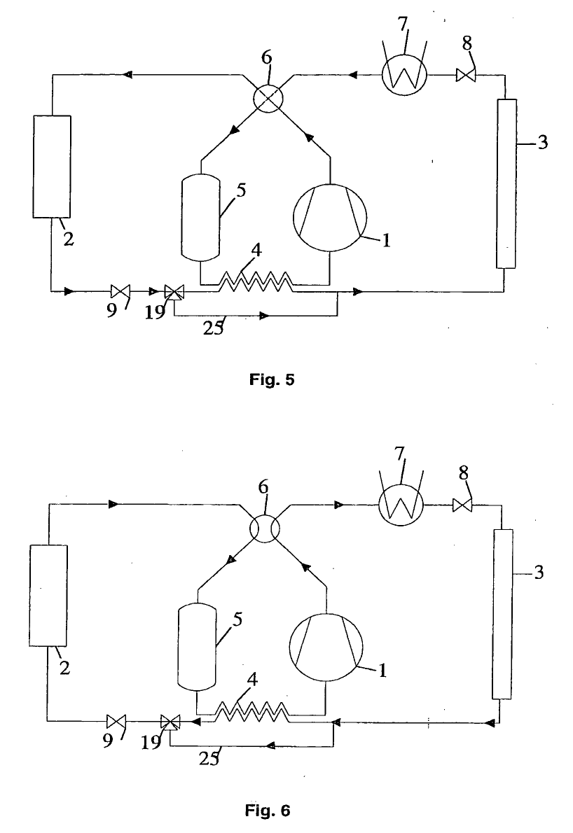

FIG. 5 and FIG. 6 show schematic representation of this embodiment in heat pump and cooling mode operation respectively. Compared to the First embodiment, it has an additional conduit and flow-diverting device 19 for bypassing the internal heat exchanger 4. It is also possible to provide a bypass conduit 25 in order to bypass the exterior heat exchanger 3 as in the Second embodiment. Under very low ambient (heat source) temperature (low evaporation temperature), it might be desirable to avoid too high discharge temperature. In such cases, the refrigerant after the multi-function expansion device 9 is totally or partially diverted by the flow-diverting device 19 in order to bypass the internal heat exchanger 4. The reversing process from heating mode to cooling mode operation is performed by using the two multi-function expansion devices 8 and 9 as described in the First embodiment.

### 4. FOURTH EMBODIMENT

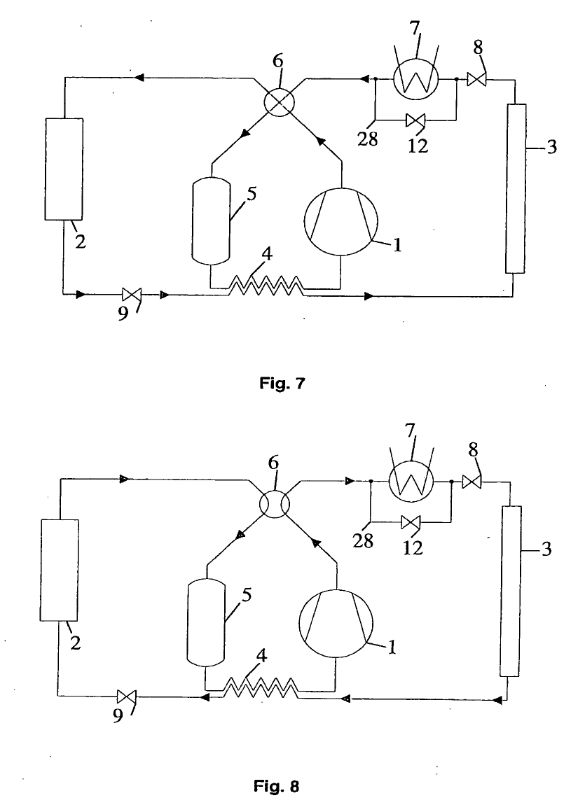

The Fourth embodiment is shown schematically in FIG. 7 and FIG. 8 in heat pump and cooling mode respectively. The main difference between this embodiment and the First embodiment is the presence of a bypass conduit 28 providing a valve 12 which add the option to bypass the auxiliary heat exchanger 7 if needed.

### 5. FIFTH EMBODIMENT

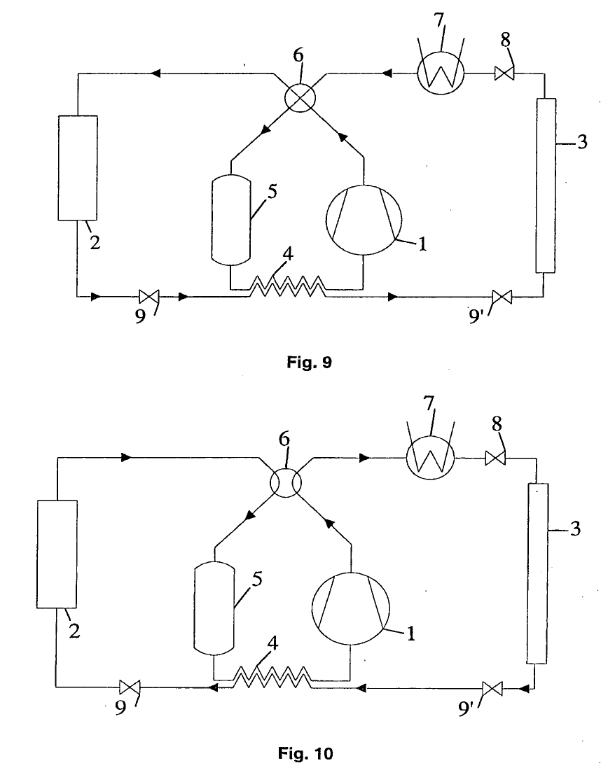

FIG. 9 and FIG. 10 show schematic representation of this embodiment in heat pump and cooling mode operation respectively. Compared to the First embodiment, it has an additional multi-function expansion device 9′ which is placed between the exterior heat exchanger 3 and internal heat exchanger 4. This embodiment represents an improvement of the First embodiment since the presence of the multi-function expansion device 9′ between the exterior heat exchanger 3 and internal heat exchanger 4 add new flexibility to the system. In heat pump mode, one can choose to expand the refrigerant after the multi-function expansion device 9′ which makes the exterior heat exchanger 3 function as heat absorber (evaporator) or to run the said heat exchanger and the auxiliary heat exchanger 7 at different evaporation temperature. This can be done by first reducing the pressure of the refrigerant to the (first) evaporation temperature in the exterior heat exchanger 3 by the multi-function expansion device 9′ and then reducing the refrigerant pressure by the multi-function expansion device 8 to the (second and lower) evaporation temperature in the auxiliary heat exchanger 7. It will also be possible for the refrigerant to flow through the said expansion device 9′ without any substantial pressure reduction such that the refrigerant can give off heat to the exterior heat exchanger 3 before its pressure is reduced by the multi-function expansion device 8. The low-pressure refrigerant then enters the auxiliary heat exchanger 7, which function as heat absorber (evaporator).

### 6. SIXTH EMBODIMENT

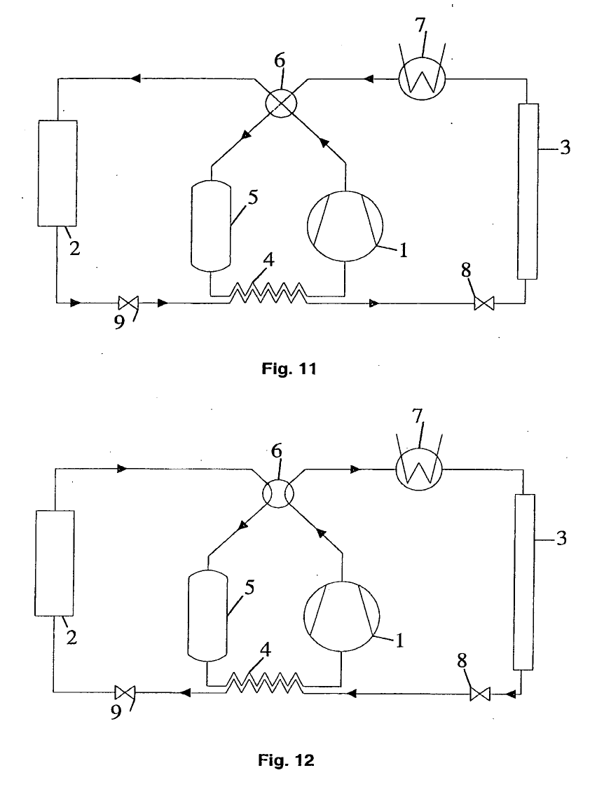

FIG. 11 and FIG. 12 show schematic representation of this embodiment in heat pump and cooling mode operation respectively. Compared to the First embodiment, the multi-function expansion valve 8 is moved to the opposite side of the exterior heat exchanger 3. As a result, the exterior heat exchanger 3 will function as evaporator in heating mode. This can be beneficial in situations where the system can use the ambient air as heat source during start-up until the engine temperature can reach normal operating temperature, after which, the excess heat from engine cooling system can be used as heat source. The reversing process from heating mode to cooling mode operation is performed by using the two multi-function expansion devices 8 and 9 as described in the First embodiment. In cooling mode operation, the pressure reduction will be carried out by the multi-function expansion device 9 as in the First embodiment.

### 7. SEVENTH EMBODIMENT

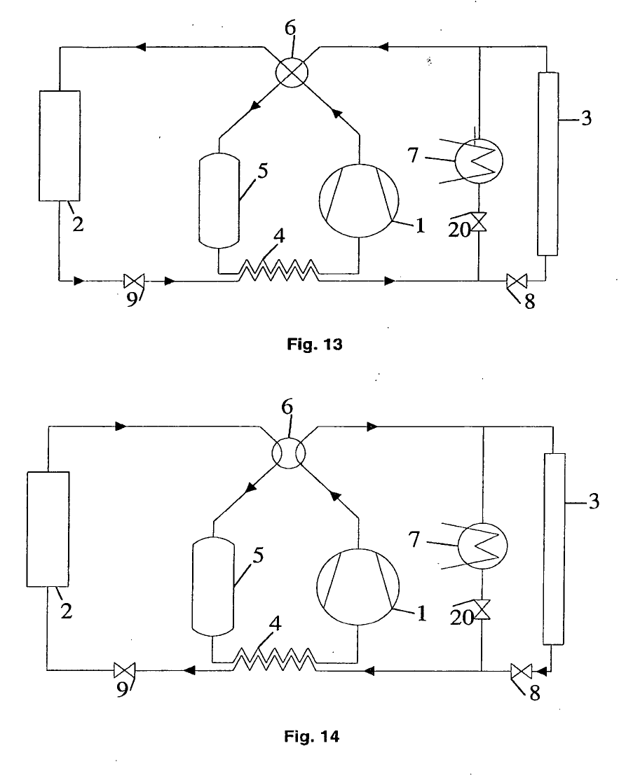

FIG. 13 and FIG. 14 show schematic representation of this embodiment in heat pump and cooling mode operation respectively. Compared to the Sixth embodiment the auxiliary heat exchanger 7 is in a separate conduit branch 26 coupled in parallel relative to the exterior heat exchanger 3 by using an additional multi function expansion device 20 provided in a bypass conduit. The system operation in heat pump and cooling mode is described with reference FIG. 13 and FIG. 14 respectively.

Heat Pump Operation (FIG. 13):

When the system is running as heat pump, the compressed refrigerant after the compressor flows first through a flow-reversing device 6 that is in heating mode. The refrigerant then enters the interior heat exchanger 2, giving off heat to the heat sink before passing through the multi-function expansion device 9 which is open, i.e. the pressure before and after is basically the same. The high-pressure refrigerant then passes through the internal heat exchanger 4 where its temperature (enthalpy) is reduced by exchanging heat with low-pressure refrigerant. The cooled high-pressure refrigerant after internal heat exchanger can then be divided into two branches. If needed, some of the refrigerant is diverted toward auxiliary heat exchanger 7 provided in parallel with the exterior heat exchanger 3. The pressure of the said refrigerant is then reduced to evaporation pressure before said auxiliary heat exchanger 7 by the additional multi function expansion device 20. The refrigerant from the auxiliary heat exchanger 7 is then directed into the inlet of the accumulator 5. The rest of the cooled high-pressure refrigerant flows through the multi-function expansion device 8 by which its pressure is reduced to the evaporation pressure. The low-pressure refrigerant then enters exterior heat exchanger 3 where it evaporates by absorbing heat. The refrigerant then passes through the flow-reversing device 6 before or after it is mixed with any refrigerant from auxiliary heat exchanger 7 and enters the accumulator 5. The refrigerant then flows through the internal heat exchanger 4 before it enters the compressor 1, completing the cycle.

Cooling Mode Operation (FIG. 14):

The flow-reversing device 6 will now be in cooling mode operation such that the interior heat exchanger 2 acts as evaporator while the exterior heat exchanger 3 as heat rejecter (condenser/gas cooler). In this mode, the compressed gas after compressor 1 passes through the flow-reversing device 6 before entering the exterior heat exchanger 3 where it is cooled down by giving off heat before it passes through the multi-function expansion device 8 without throttling (the pressure before and after remains basically constant). It will be also possible to give off some heat in the auxiliary heat exchanger 7 by diverting some refrigerant through the multi function expansion device 20. The high-pressure refrigerant is further cooled down in the internal heat exchanger 4 before its pressure is reduced to evaporation pressure by the multi-function expansion device 9. The low-pressure refrigerant evaporates by absorbing heat in the internal heat exchanger 2. The refrigerant then passes through the flow-reversing device 6 before it is mixed with any of the refrigerant from the auxiliary heat exchanger 7 before it enters the accumulator 5. The refrigerant then passes the internal heat exchanger 4 before it enters the compressor 1, completing the cycle.

### 8. EIGHTH EMBODIMENT

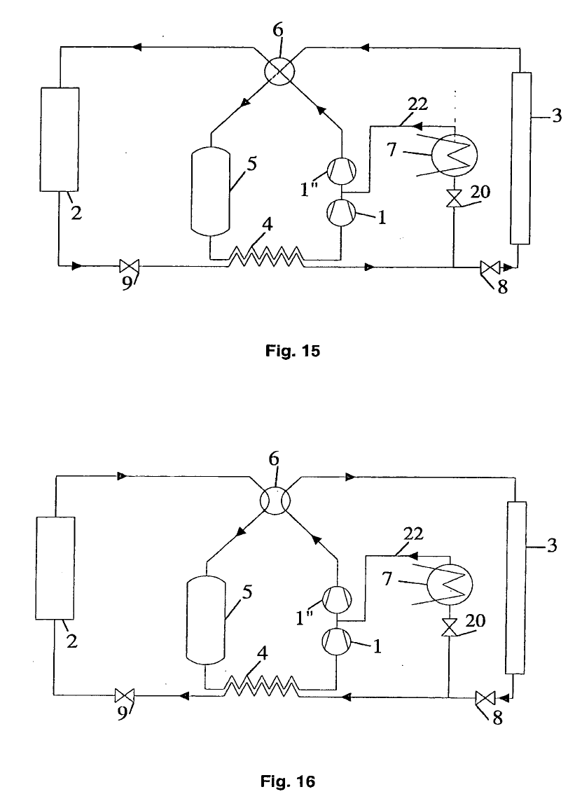

The Eighth embodiment is shown schematically in FIG. 15 in heat pump mode and FIG. 16 in cooling mode operation. Compared to the Seventh embodiment, this embodiment represents a two stage compression system where the refrigerant from the auxiliary heat exchanger 7 is directed to the discharge side of the first stage compressor 1 through a circuit loop 22 before it is compressed by the second stage compressor 1″. As a result, the evaporation pressure in the auxiliary heat exchanger 7 will be independent and it will correspond to the intermediate pressure (the pressure after the first stage compressor 1). The reversing process from heating mode to cooling mode operation is performed as described in the Seventh embodiment.

### 9. NINTH EMBODIMENT

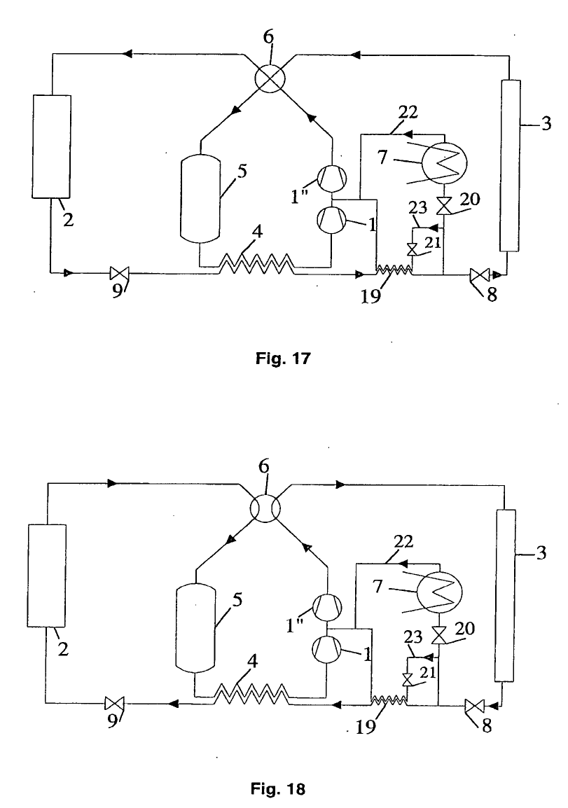

The Ninth embodiment is shown schematically in FIG. 17 in heat pump mode and FIG. 18 in cooling mode operation. Compared to the Eighth embodiment this embodiment has an additional inter-cooling heat exchanger 19 provided in an additional circuit loop 23 which at one end is connected to the circuit loop 22 prior to the auxiliary heat exchanger 7 and at the other end to the circuit loop 22 after the heat exchanger 7 and a valve 21 provided in the circuit loop 22 between the expansion device 20 and the auxiliary heat exchanger 7. In heating mode the valve 21 will be open and some of the refrigerant after the expansion device 20 is diverted to the inter-cooling heat exchanger 19 where the said refrigerant is evaporated in heat exchange with high pressure after internal heat exchanger 4. In cooling mode the valve 21 will be closed and refrigerant after expansion device 20 will flow through the inter-cooling heat exchanger 19 where it evaporates in heat exchange with high pressure refrigerant after the multi-function expansion device 8. In both cases, it results in de-superheating of the discharge gas after first stage compressor 1 that results in lower specific work of compression and better system performance. The reversing process from heating mode to cooling mode operation is performed as described in the Eighth embodiment .

### 10. TENTH EMBODIMENT

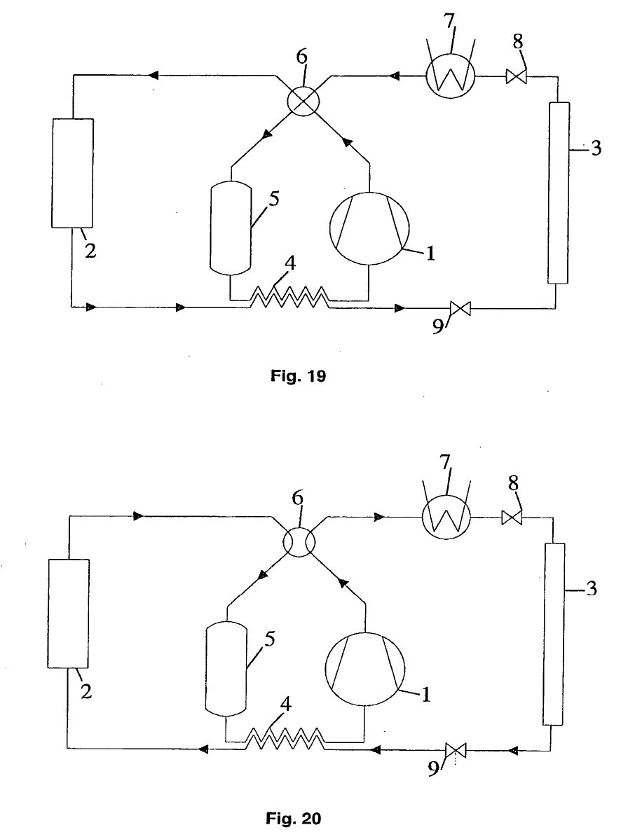

The Tenth embodiment is shown schematically in FIG. 19 in heat pump mode and FIG. 20 in cooling mode operation. Compared to the First embodiment, the only difference is the location of the multi-function expansion valve 9 where in this embodiment it is placed between the exterior heat exchanger 3 and the internal heat exchanger 4. It is also possible to provide a bypass conduit in order to bypass the exterior heat exchanger 3 as in the Second embodiment. In heat pump mode, expansion may thus take place in multi-function expansion device 9 to absorb heat in the exterior heat exchanger 3, or expansion may take place in multi-function expansion device 8 to absorb heat in the auxiliary heat exchanger 7. In the latter case it would be possible to bypass the exterior heat exchanger 3 using a bypass conduit (not shown in the figure) as in the Second embodiment. Thus, the heat source may be ambient air during start-up, and then switched to engine coolant when the coolant temperature has reached an acceptable level. During cooling mode operation, the pressure on both sides of the internal heat exchanger 4 will be basically the same with no temperature driving force for exchange of heat. As a result, the internal heat exchanger 4 will be active only in one operational mode, either cooling mode or heat pump operation. The reversing process is performed as in the First embodiment.

### 11. ELEVENTH EMBODIMENT

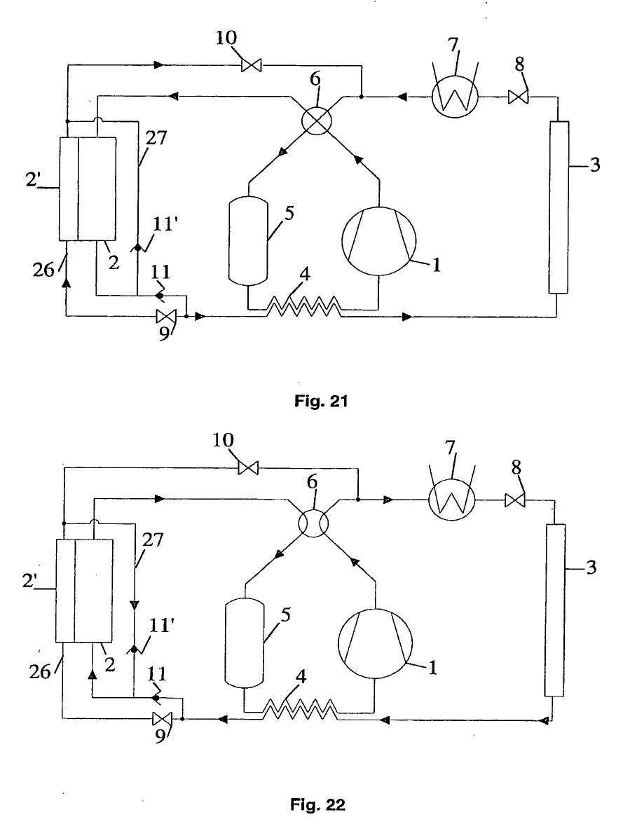

FIG. 21 and FIG. 22 show schematic representation of this embodiment in heat pump and cooling mode operation respectively. Compared to the First embodiment, it incorporate an additional dehumidification heat exchanger 2′ provided in a third circuit loop 25 which at one end is connected to the main circuit between the flow reversing device 6 and auxiliary heat exchanger 7 and at the other end is connected between the internal heat exchanger 4 and interior heat exchanger 2, two check valves 11 and 11′ provided in a fourth circuit loop 24 between the main circuit and the third circuit loop 25, and a valve 10 (for example solenoid valve) provided in the third circuit loop 25. The system operation in heat pump and cooling mode is described with reference to FIG. 21 and FIG. 22 respectively.

Heat Pump Operation (FIG. 21):

In heat pump mode operation, the compressed refrigerant after the compressor flows first through the flow-reversing device 6 that is in heating mode. The refrigerant then enters the interior heat exchanger 2, giving off heat to the heat sink. The high-pressure refrigerant passes through the check valve 11 and the then through the internal heat exchanger 4 where its temperature (enthalpy) is reduced by exchanging heat with low-pressure refrigerant. The cooled high-pressure refrigerant then enters exterior heat exchanger 3 before its pressure is reduced to the evaporation pressure by the multi-function expansion device 8. It would also be possible to bypass the exterior heat exchanger 3 using a bypass conduit (not shown in the figure) as in the Second embodiment. The low-pressure refrigerant enters the auxiliary heat exchanger 7 where it evaporates by absorbing heat. When the dehumidification heat exchanger 2′ is on, some of the high-pressure refrigerant after the check valve 11 is bled off by the multi-function expansion device 9 into the dehumidification heat exchanger 2′ where it is evaporated, thereby dehumidifying the interior air. The low-pressure refrigerant passes through the valve 10 that is open and is mixed with refrigerant from the auxiliary heat exchanger 7. The refrigerant then passes through the flow-reversing device 6, accumulator 5 and the internal heat exchanger 4 respectively, before it enters the compressor, completing the cycle.

Cooling Mode Operation (FIG. 22):

The flow-reversing device 6 will now be in cooling mode operation such that the interior heat exchanger 2 and the dehumidification heat exchanger 2′ together act as evaporator while the exterior heat exchanger 3 as heat rejecter (condenser/gas cooler). In this mode, the compressed gas after compressor 1 passes through the flow-reversing device 6 before entering auxiliary heat exchanger 7. Depending on whether auxiliary heat exchanger 7 is in operation the high-pressure refrigerant can be cooled down before it passes through the multi-function expansion device 8 without throttling (the pressure before and after remains basically constant). The high-pressure refrigerant then enters the exterior heat exchanger 3 where it is cooled down by giving off heat. The refrigerant is further cooled down in the internal heat exchanger 4 before its pressure is reduced to evaporation pressure by the multi-function expansion device 9. The low-pressure refrigerant evaporates by absorbing heat first in the dehumidification heat exchanger 2′. It then passes through check valve 11′ (valve 10 is closed) before it is further evaporated in the interior heat exchanger 2. The refrigerant then passes through the flow-reversing device 6, accumulator 5 and the internal heat exchanger 4 respectively, before it enters the compressor, completing the cycle.

### 12. TWELFTH EMBODIMENT

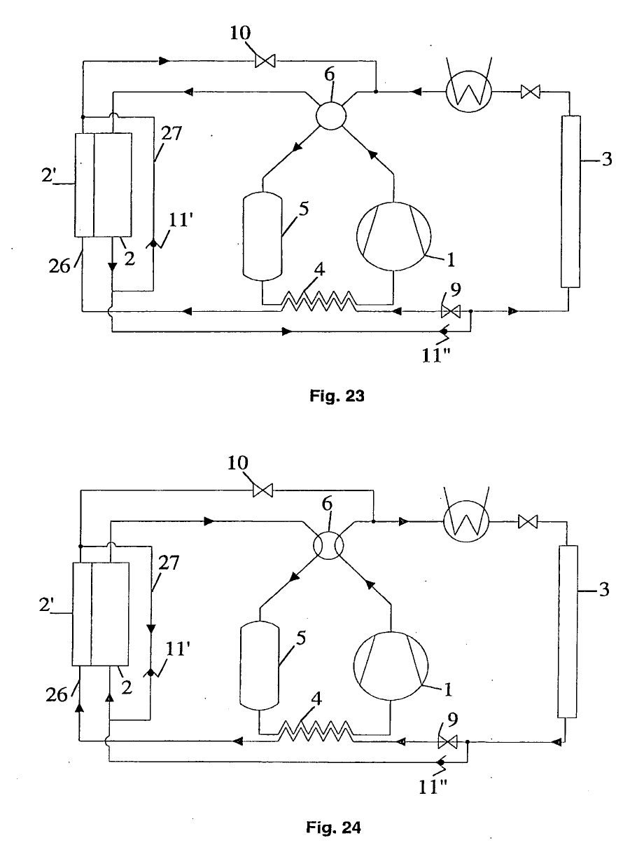

The Twelfth embodiment is shown schematically in FIG. 23 in heat pump mode and FIG. 24 in cooling mode operation. Compared to the Sixth embodiment, it incorporate an additional dehumidification heat exchanger 2′ as for the tenth embodiment, but the one end of the interior heat exchanger is now connected with the main circuit through a conduit 27 between the exterior heat exchanger 3 and the internal heat exchanger 4 and the dehumidification heat exchanger 2′ is connected with the internal heat exchanger 4. In addition to the check valve 11′ provided in the fourth circuit loop 24, a check valve 11″ is provided in the conduit 27.

In terms of operation and compared to the Eleventh embodiment, the only difference is the location of the multi-function expansion valve 9 where in this embodiment it is placed between the exterior heat exchanger 3 and the internal heat exchanger 4. In heat pump mode, expansion may thus take place in multi-function expansion device 9 to absorb heat in the exterior heat exchanger 3, or expansion may take place in multi-function expansion device 8 to absorb heat in the auxiliary heat exchanger 7 in which case it would be possible to bypass the exterior heat exchanger 3 using a bypass conduit (not shown in the figure) as in the First embodiment. Thus, the heat source may be ambient air during start-up, and then switched to engine coolant when the coolant temperature has reached an acceptable level. During cooling mode operation, the pressure on both sides of the internal heat exchanger 4 will be basically the same with no temperature driving force for exchange of heat. As a result, the internal heat exchanger 4 will be active only in one operational mode, either cooling mode or heat pump operation. The reversing process from heat pump mode to cooling mode operation is performed as described in the Eleventh embodiment.

### 13. THIRTEENTH EMBODIMENT

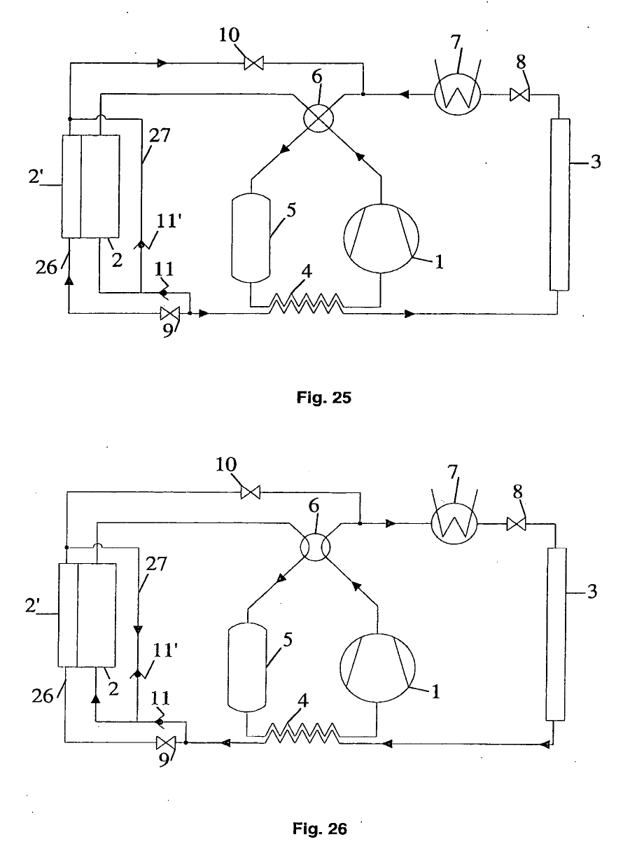

FIG. 25 and FIG. 26 show schematic representation of this embodiment in heat pump and cooling mode operation respectively. Compared to Eleventh embodiment, the only difference is the addition of a by-pass valve 12, which enables the refrigerant to by-pass the auxiliary heat exchanger 7 if needed.

### 14. FOURTEENTH EMBODIMENT

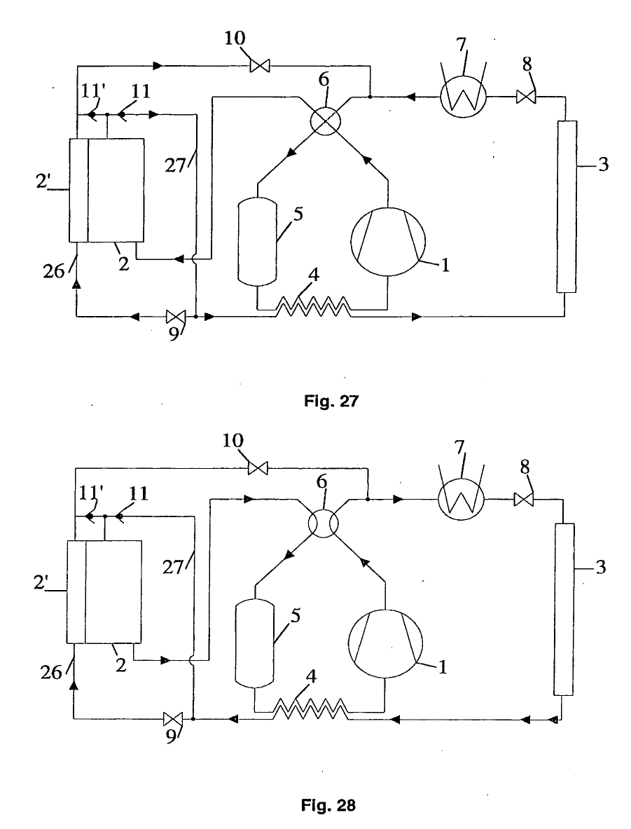

The Fourteenth embodiment is shown schematically in FIG. 27 in heat pump mode and FIG. 28 in cooling mode operation. This is embodiment is basically the same as the Twelfth embodiment except for the location of check valve 11 which has been replaced by another check valve 11′″, between the outlet of the dehumidification heat exchanger 2′ and inlet of the interior heat exchanger 2. The reversing of system operation from cooling mode to heat pump mode is performed as in the Twelfth embodiment.

### 15. FIFTEENTH EMBODIMENT

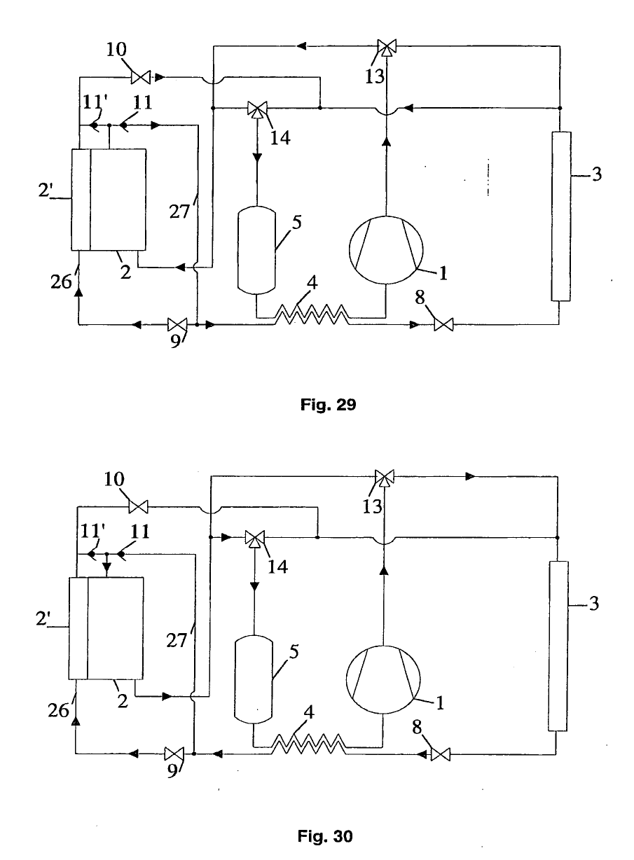

FIG. 29 and FIG. 30 show schematic representation of the Fifteenth embodiment in heat pump and cooling mode operation respectively. Compared to previous embodiments, the main difference lies in the way the reversing is performed. In this embodiment, the flow-reversing device 6 has been replaced by two flow-diverting devices 13 and 14. The system operation in heat pump and cooling mode is described with reference to FIG. 29 and FIG. 30 respectively.

Heat Pump Operation (FIG. 29):

In heat pump mode operation, the flow-diverting devices 13 and 14 are in heating mode. The compressed refrigerant after the compressor flows first through the flow-diverting device 13 before entering interior heat exchanger 2, giving off heat to the heat sink. The high-pressure refrigerant passes through the check valve 11′ and the then through the internal heat exchanger 4 where its temperature (enthalpy) is reduced by exchanging heat with low-pressure refrigerant. The pressure of the refrigerant is reduced to the evaporation pressure by the multi-function expansion device 8 before it enters exterior heat exchanger 3. When the dehumidification heat exchanger 2′ is on, some of the high-pressure refrigerant after the check valve 11′ is bled by the multi-function expansion device 9 into the dehumidification heat exchanger 2′ where it is evaporated, dehumidifying the interior air. The low-pressure refrigerant passes through the valve 10 that is open before it is mixed with refrigerant from the exterior heat exchanger 3. The refrigerant then passes through the flow-diverting device 6, accumulator 5 and the internal heat exchanger 4 respectively, before it enters the compressor, completing the cycle.

Cooling Mode Operation (FIG. 30):

In heat pump mode operation, the flow-diverting devices 13 and 14 are in cooling mode such that the interior heat exchanger 2 and the dehumidification heat exchanger 2 acts as evaporator while the exterior heat exchanger 3 heat rejecter (condenser/gas cooler). In this mode, the compressed gas after compressor 1 passes through the flow-diverting device 13 before entering exterior heat exchanger 3. The high-pressure refrigerant then passes through the multi-function expansion device 8 without throttling (the pressure before and after remains basically constant). The refrigerant then enters the internal heat exchanger 4 where it is cooled down by giving off heat to the low-pressure refrigerant on the other side of the heat exchanger. The pressure of the refrigerant is then reduced to evaporation pressure by the multi-function expansion device 9. The low-pressure refrigerant evaporates by absorbing heat first in the dehumidification heat exchanger 2′. It then passes through check valve 11′″ (valve 10 is closed) before it is further evaporated in the interior heat exchanger 2. The refrigerant then passes through the flow-diverting device 6, accumulator 5 and the internal heat exchanger 4 respectively, before it enters the compressor, completing the cycle.

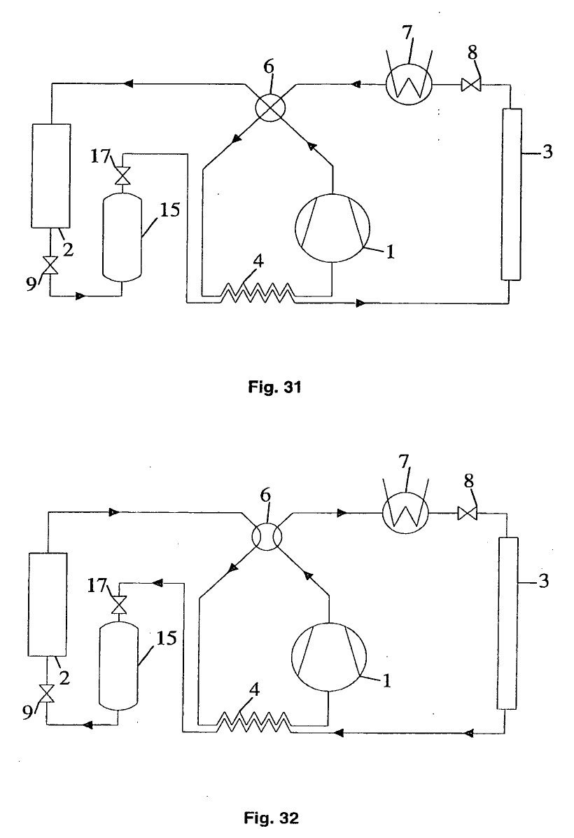

### 16. SIXTEENTH EMBODIMENT (FIGS. 31 AND 32)

This embodiment includes a compressor 1, a flow-reversing device 6, an interior heat exchanger 2, a multi function expansion device 17, an intermediate pressure accumulator 15, an internal heat exchanger 4, an exterior heat exchanger 3, two multi-function expansion devices 8 and 9, and an auxiliary heat exchanger 7. The system operation in heat pump and cooling mode is described with reference to FIG. 31 and FIG. 32 respectively.

Heat Pump Operation (FIG. 31):

The compressed refrigerant after the compressor flows first through a flow-reversing device 6 that is in heating mode. The refrigerant then enters the interior heat exchanger 2, giving off heat to the heat sink before passing through the expansion device 9 by which the refrigerant pressure is reduced to intermediate pressure. The expansion device can be open in which case there would be no pressure reduction by the said expansion device, and the pressure in the internal heat exchanger 4 and the exterior heat exchanger 3 will be basically the same as intermediate pressure. The refrigerant pressure is then reduced to evaporation pressure before the auxiliary heat exchanger 7 by the multi-function expansion device 8. The low-pressure vapor then flows through the flow reversing device 6 before entering internal heat exchanger 4 and compressor 1 at the end. In case there would be some pressure reduction in the multi function expansion device 17, the pressure in the internal heat exchanger 4 and exterior heat exchanger 3 will be somewhere in between pressure in the intermediate accumulator 15 and the evaporation pressure in the auxiliary heat exchanger 7. In both cases it would be possible to bypass the internal heat exchanger 4 and exterior heat exchanger 3 or both, using a bypass conduit (not shown in the figures).

Cooling Mode Operation (FIG. 32):

The flow-reversing device 6 will now be in cooling mode operation such that the interior heat exchanger 2 acts as evaporator while the exterior heat exchanger 3 as heat rejecter (condenser/gas cooler). In this mode, the compressed gas after compressor 1 passes through the flow-reversing device 6 before entering auxiliary heat exchanger 7. Depending on whether auxiliary heat exchanger 7 is in operation the high-pressure refrigerant can be cooled down before it passes through the multi-function expansion device 8 without throttling (the pressure before and after remains basically constant). The high-pressure refrigerant then enters the exterior heat exchanger 3 where it is cooled down by giving off heat. The refrigerant then flows through the internal heat exchanger 4 where it is further cooled down before its pressure is reduced to the accumulator pressure by the multi function expansion device 17. After the accumulator, the refrigerant pressure is reduced by the expansion device 9 to the evaporation pressure in the interior heat exchanger 2. The low-pressure refrigerant evaporates by absorbing heat in the said heat exchanger. Afterward, the refrigerant passes through the flow-reversing device 6 and the internal heat exchanger 4 respectively, before it enters the compressor, completing the cycle.

### 17. SEVENTEENTH EMBODIMENT

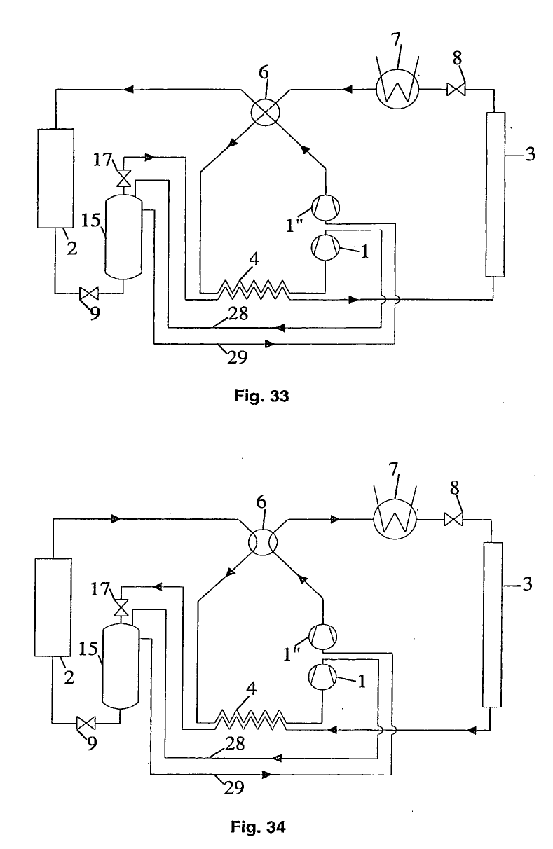

FIG. 33 and FIG. 34 show schematic representations of the Seventeenth embodiment in heat pump and cooling mode operation, respectively. The main difference between this embodiment and Sixteenth embodiment is that the compression process is carried out in two stages by two compressors 1 and 1″. The discharge refrigerant gas from the first stage compressor 1 is directed into the intermediate pressure accumulator that result in de-superheating of the said refrigerant. As a result, the suction gas for the second stage compressor 1″ can be saturated or close to saturated, which compared to one stage compression (Sixteenth embodiment), results in a lower specific compression work. The operation of the system in heating and cooling mode is otherwise the same as in Sixteenth embodiment.

It is also understood that the accumulator presented in different figures is a schematic representation where the actual solution could differ from those shown in these figures.

1-14. (canceled)

15. A reversible vapor compression system for heating and comfort cooling of a vehicle cabin or passenger compartment, including at least a compressor (1), a flow reversing device (6), an interior heat exchanger (2), a multi-function expansion device (9), an internal heat exchanger (4), an exterior heat exchanger (3), another multi-function expansion device (8), an auxiliary heat exchanger (7) through which a coolant is circulated and an accumulator (5) connected in an operational relationship through conduits to form a closed main circuit, wherein the inter-connection of the components (1, 2, 3, 4, 5, 6, 7, 8, 9) of the system are provided such that ambient air and coolant circulated from the vehicle drive system can both partially or fully be used as heat source and heat sink in heat pump mode and comfort cooling mode, respectively.

16. System according to claim 15, wherein the reversing process from heat pump to comfort cooling mode operation, and vice versa, is performed by means of a flow reversing device (6) connected to the high pressure side of the compressor (1) and the inlet of the accumulator (5) and two multi-function expansion devices (8) and (9) provided in the circuit respectively between the auxiliary heat exchanger (7) and exterior heat exchanger (3) and between the interior heat exchanger (2) and internal heat exchanger (4).

17. System according to claim 15, wherein the reversing process from heat pump to comfort cooling mode operation, and vice versa, is performed by means of a flow reversing device (6) connected to the high pressure side of the compressor (1) and the inlet of the accumulator (5), and three multi-function expansion devices (8, 9) and (9)′, where expansion takes place in the multi-function expansion device (9)′ between the internal heat exchanger (4) and exterior heat exchanger (3) when ambient air or a combination of ambient air and coolant is used as heat source in heat pump mode, and expansion takes place in the multi-function expansion device (8) between auxiliary heat exchanger (7) and exterior heat exchanger (3) when coolant is used as the only heat source.

18. System according to claim 15, wherein an additional bypass conduit (24) including a valve (12) is provided in parallel with the exterior heat exchanger (3).

19. System according to claim 15, wherein a further bypass conduit (25) and flow-diverting device (19) for bypassing the internal heat exchanger (4) is provided in parallel with the internal heat exchanger (4).

20. System according to claim 15, wherein the multi-function expansion device (8) is placed between the exterior heat exchanger (3) and the internal heat exchanger (4).

21. System according to claim 20, wherein the auxiliary heat exchanger (7) is connected by a conduit in parallel relative to exterior heat exchanger (3), with an expansion device (20) provided on the up stream side of the auxiliary heat exchanger when the system is in heating mode operation.

22. System according to claim 21, wherein the compression is performed by two compressors (1) and (1″) in two stages and that the refrigerant from the auxiliary heat exchanger (7) is mixed with the discharge refrigerant from compressor (1) through a circuit loop (22).

23. System according to claim 22, wherein an additional inter-cooler heat exchanger (19) is provided in an additional circuit loop (23) between the circuit loop, (22) prior to the auxiliary heat exchanger (7) and expansion device (20), and the interconnection of the compressors (1, 1′) and that a valve (21) is provided in the circuit loop (23) to control the flow through the inter-cooler heat exchanger (7).

24. System according to claim 22, wherein the two-stage compressors (1, 1′) are in the form of a single compound compressor.

25. System according to claim 15, wherein the multi-function expansion device (9) is placed between the internal heat exchanger (4) and the exterior heat exchanger (3).

26. System according to claim 15, wherein an additional dehumidification heat exchanger (2′) provided in a third conduit loop (26) which at one end is connected to the main circuit between the accumulator (5) and auxiliary heat exchanger (7) and the other end between the internal heat exchanger (4) and interior heat exchanger (2), two check valves (11) and (11′) provided in a fourth conduit loop (27) between the main circuit and third conduit loop (26) and a valve (10) provided in the third loop (26), whereby the dehumidification heat exchanger (2′) and the interior heat exchanger (2) are connected in series in cooling mode operation whereas in heating mode, the same said dehumidification heat exchanger (2)′ will dehumidify the air before it is heated up by the interior heat exchanger (2).

27. System according to the claim 15, wherein an intermediate accumulator (15) is provided in the main circuit between the internal heat exchanger (4) and multi function expansion device (9) and that another multifunction expansion device (17) is provided between the pressure accumulator (15) and the external heat exchanger (4).

28. System according to claim 13, wherein the compression process is carried out in two stages using a first stage compressor (1) and a second stage compressor (1″) and that the discharge refrigerant from the first stage is directed into the intermediate pressure accumulator (15) before it enters the second stage compressor (1″).
